(19) United States
(12) Patent Application Publication
(10) Pub. No.: US 2014/0045116 A1
(43) Pub. Date: Feb. 13, 2014

(54) EMULSION AGGREGATION TONER PROCESS COMPRISING DIRECT ADDITION OF SURFACE-TREATED PIGMENT

(71) Applicants: Enno E. AGUR, Toronto (CA); Shigang S. QIU, Etobicoke (CA); Ke ZHOU, Mississauga (CA); Cuong VONG, Hamilton (CA); Edward G. ZWARTZ, Mississauga (CA); Santiago FAUCHER, Oakville (CA)

(72) Inventors: Enno E. AGUR, Toronto (CA); Shigang S. QIU, Etobicoke (CA); Ke ZHOU, Mississauga (CA); Cuong VONG, Hamilton (CA); Edward G. ZWARTZ, Mississauga (CA); Santiago FAUCHER, Oakville (CA)

(73) Assignee: XEROX CORPORATION, Norwalk, CT (US)

(21) Appl. No.: 13/568,786

(22) Filed: Aug. 7, 2012

(51) Int. Cl. G03G 9/08; G03G 9/09; G03G 9/093

(52) U.S. Cl. 430/137.11; 430/137.14

(57) ABSTRACT

A method of making a toner that includes adding pigments into an emulsion aggregation toner without first preparing a pigment dispersion. The method eliminates the pigment dispersion step in the manufacture of emulsion aggregation toilers by surface-treating pigments. Dry surface-treated pigments can be directly incorporated into the toner prior to aggregation in the aggregation coalescence process without the need to first prepare aqueous pigment dispersions.

### TECHNICAL FIELD

The present disclosure is generally directed to a process of making toner compositions and, more specifically, an emulsion aggregation process that does not require first forming an dispersion of the pigment particle. The toners made according to the processes of the present disclosure have desirable characteristics, including gloss.

### BACKGROUND

Electrophotographic printing utilizes toner particles that may be produced by a variety of processes. One such process includes an emulsion aggregation (“EA”) process that forms toner particles. See, for example, U.S. Pat. No. 6,120,967, the disclosure of which is hereby incorporated by reference in its entirety, as one example of such a process.

In conventional EA toner processes, the major toner components are added in the form of aqueous emulsions or dispersions. These include polymer latex emulsion, pigment dispersion, and wax dispersion. Conventional practice for preparing pigment dispersions for EA toner applications has been to (1) mix the pigment and water in the presence of a small amount of an organic surfactant to enhance surface wetting of the pigment, (2) reduce the particle size of the pigment by means of high intensity mixing and/or milling, and (3) stabilize the dispersion with the organic surfactant.

Such pigment dispersion processes entail high capital cost equipment and high energy usage. Eliminating the external pigment dispersion step may, among other things, significantly reduce the cost of making a toner. Therefore, there is a need for a process of making an EA toner wherein pigments may be incorporated directly into the toner composition without the need for an external or separate pigment dispersion step.

### SUMMARY

The present disclosure provides processes for making EA toner compositions without first forming a pigment dispersion or emulsion. The process may comprise forming a pre-toner mixture by mixing a resin emulsion, dry surface-treated pigment particles, and an optional wax emulsion; aggregating particles from the pre-toner mixture; halting the aggregating of the particles; and coalescing the particles to form toner particles, wherein the dry surface-treated pigment particles are added directly to the pre-toner mixture without first forming a pigment dispersion.

### BRIEF DESCRIPTION OF THE DRAWINGS

Various embodiments of the present disclosure will be described herein below with reference to the figures.

FIG. 1 shows thermogravimetric (TGA) measurements of the toner particle of Example 1.

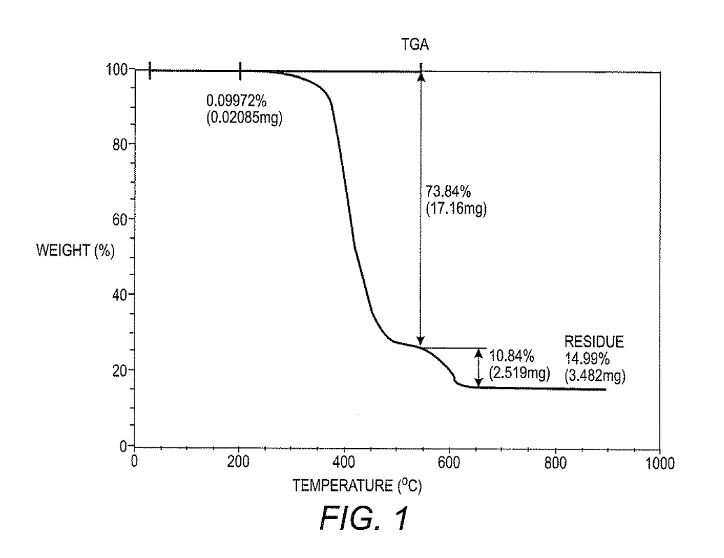

FIG. 2 shows TGA measurements of the toner particle of Example 2.

FIG. 3 shows plots of electric loss v. pigment loading of two TiO₂ particles.

FIG. 4 shows plots of 60 min Q/d v. pigment loading for two TiO₂ particles.

FIG. 5 shows plots of crease area v. fusing temperature.

FIG. 6 shows plots of gloss v. fusing temperature.

### DETAILED DESCRIPTION

The present disclosure provides chemical processes to incorporate pigments, including black, white, and colored pigments, into an EA toner. The processes herein eliminate the pigment dispersion step in the manufacture of EA toners using dry surface-treated pigments. The dry surface-treated pigments are directly incorporated into the toner formulation, prior to aggregation in the emulsion aggregation coalescence process, without the need to first prepare aqueous pigment dispersions. That is to say, the dry surface-treated pigment is not separately dispersed in an aqueous pigment dispersion before the dry surface-treated pigment is added to the toner formulation.

In embodiments, toner compositions and toner particles may be prepared by aggregation and coalescence processes in which small-size resin particles are aggregated to the appropriate toner particle size and then coalesced to achieve the final toner particle shape and morphology.

As discussed above, EA toner processes conventionally include secondary or external process steps of forming an aqueous pigment dispersion. Due to expensive equipment and high energy use, manufacturing pigment dispersions can be costly, especially where the loading of pigment in the toner is high, adding significantly to the cost of the toner. Eliminating this costly step represents a significant cost saving opportunity when manufacturing high quantities of EA toner.

Applicants have developed an EA toner process that eliminates the step of forming aqueous pigment dispersions. Instead, a dry pigment is incorporated directly into the toner formulation without the need for a secondary dispersion step. A dry pigment may be incorporated directly into an EA toner formulation when the dry pigment is a surface-treated pigment.

### Surface-Treated Pigment

The pigment particles are surface treated to assist their dispersability in the remaining toner formation components. Such surface treatment can, for example, mask functional groups that may be present on the pigment particles that would otherwise interfere with pigment mixing into the other toner components, or the surface treatment can provide alternative functional groups or the like that will instead assist with pigment mixing, without the pigment being first dispersed in a dispersion or an emulsion. Any suitable surface treatment or combination of two or more treatments may be applied to the desired pigment particles to provide the desired mixing properties.

For example, the pigment particles may be subjected to an organic treatment, whereby an organic material is coated over the pigment particles. The organic material may, for example, improve compatibility and dispersability of the pigment particles in organic or aqueous binder liquids. The surface coating may also be described as acting as a physical spacer, maintaining separation between adjacent pigment particles especially as pigment concentration increases. The organic material for coating may often be polyols, amines or amine salts. Silicones, siloxanes, and silicone derivatives are commonly used as well. The organic treatment may contain, for example, aliphatic hydrocarbons with ether, ester, and/or hydroxyl functionality, wherein the weight fraction of the organic surface coating ranges from about 0.1% to about 5%, such as from about 0.2% to about 3%, or from about 0.5% to about 2%.

The organic surface treatment may include, for example, organic surface treatments described in U.S. Pat. No. 7,935,753 to Thomas, such as ethylene glycol esters and diesters that contain ethylene glycol moieties and have the general formula ROC(OCH₂CH₂)ₙOCOR, where n in a real number from two to about fourteen and R is a straight-chain or branched-chain alkyl group containing at least two up to about fifteen carbon atoms. These materials may be incorporated on the pigment in a total amount ranging from 0.01 to about 1 weight percent based on the pigment, and may be combined with other suitable inorganic oxide and organic surface treatments. For example, trimethylolpropane (commonly, TMP) may be deposited on the surface of the pigment in an comparable amount, ranging in preferred embodiments up to about 1 percent by weight based on the pigment. The organic surface treatment materials may include, for example, triethylene glycol di-2-ethylhexoate, presently commercially available from The C.P. Hall Company, Chicago, Ill. as TegMeR® 803 glycol ester (CAS No. 94-28-0); tetraethylene glycol di-2-ethylhexoate, presently commercially available from The C.P. Hall Company, Chicago, Ill. as TegMeR® 804 glycol ester (CAS No. 18268-70-7); and polyethylene glycol di-2-ethylhexoate, presently commercially available from The C.P. Hall Company, Chicago, Ill. as TegMeR® 809 glycol ester (CAS No. 9004-93-7).

The organic surface treatment may include, for example, organic surface treatments described in U.S. Pat. No. 7,795,330 to Birmingham et al., such as an organo-silane, an organo-siloxane, a fluoro-silane, an organo-phosphonate, an organo-acid phosphate, an organo-pyrophosphate, an organo-polyphosphate, an organo-metaphosphate, an organo-phosphinate, an organo-sulfonic compound, a hydrocarbon-based carboxylic acid, an associated ester of a hydrocarbon-based carboxylic acid, a derivative of a hydrocarbon-based carboxylic acid, a hydrocarbon-based amide, a low molecular weight hydrocarbon wax, a low molecular weight polyolefin, a co-polymer of a low molecular weight polyolefin, a hydrocarbon-based polyol, a derivative of a hydrocarbon-based polyol, an alkanolamine, a derivative of an alkanolamine, an organic dispersing agent, and the like, and mixture thereof. The organic surface treatment may be an organo-silane having the formula: R⁵ₓSiR⁶₄₋ₓ wherein R⁵ is a nonhydrolyzable alkyl, cycloalkyl, aryl, or aralkyl group having at least 1 to about 20 carbon atoms; R⁶ is a hydrolyzable alkoxy, halogen, acetoxy, or hydroxy group; and x is from 1 to 3. For example, the organo-silane may be octyltriethoxysilane.

In some instances, such as depending upon the specific pigment being used, additional treatments may be used. For example, in the case of TiO₂ pigment particles, multiple treatments may be used to provide other benefits or properties in addition to the improved pigment compatibility. For example, the pigment particles may first be subjected to a SiO₂ treatment, which is applied to the core of the pigment particle to minimize weathering of the coating polymer. Otherwise, upon UV light absorption, the pigment particle may become a photocatalyst releasing free radicals that react with and chemically break down the organic binder, and exhibit weathering or chalking. Next, the pigment particle may be treated with an Al₂O₃ treatment. Treating a pigment particle with an Al₂O₃ treatment may stabilize the particle in liquid systems with respect to reflocculation.

The pigment of the dry surface-treated pigment that is directly incorporated into EA toner formulations without being dispersed in a dispersion may include, for example, the following pigments.

Illustrative examples of black pigments may include carbon black, such as REGAL 330®; magnetites, such as Mobay magnetites MO8029™, MO8060™; Columbian magnetites; MAPICO BLACKS™; Pfizer magnetites CB4799™, CB5300™, CB5600™, MCX6369™; Bayer magnetites, BAYFERROX 8600™, S610™; Northern Pigments magnetites, NP604™, NP608™; Magnox magnetites TMB-100™, or TMB-104™; NIPex® from Orion Engineered Carbons, and the like, and mixtures thereof.

Illustrative examples of white pigments may include titanium oxides, such as titanium dioxide.

Illustrative examples of cyan pigments include copper tetra(octadecyl sulfonamido) phthalocyanine, x-copper phthalocyanine pigment listed in the Color Index as CI-74160, CI Pigment Blue, Pigment Blue 15:3, and Anthrathrene Blue, identified in the Color Index as CI-69810, Special Blue X-2137, and the like, and mixtures thereof.

Illustrative examples of magenta pigments include 2,9-dimethyl-substituted quinacridone and anthraquinone dye identified in the Color Index as CI-60710, CI Dispersed Red 15, diazo dye identified in the Color Index as CI-26050, CI Solvent Red 19, and the like, and mixtures thereof.

Illustrative examples of yellow pigments include diarylide yellow 3,3-dichlorobenzidene acetoacetanilides, a monoazo pigment identified in the Color Index as CI-12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL, and the like, and mixtures thereof.

Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BUD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann. of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like, and mixtures thereof.

Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E. D. TOLUIDINE RED and 130N RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like, and mixtures thereof.

The amount of the dry surface-treated pigment may be from about 1 weight percent to about 50 weight percent of the toner, in embodiments from about 10 weight percent to about 35 weight percent of the toner, such as from about 15 weight percent to about 30 weight percent of the toner, such as from about 5 to about 25 weight percent of the toner, or from about 5 to about 15 weight percent of the toner. However, amounts outside these ranges can also be used. Toners of the present disclosure may possess a gloss level of from about 10 Gardner gloss units (gu) to about 90 gu, in embodiments from about 15 gu to about 70 gu, such as from about 20 gu to about 50 gu.

In embodiments, toners of the present disclosure may be combined with other color toners in an electrophotographic apparatus to form a desired image. As additional colorants to be added to form other color toners, various known suitable colorants, such as dyes, pigments, mixtures of dyes, mixtures of pigments, mixtures of dyes and pigments, and the like, may be included in the toner. The additional colorant may be included in the toner in an amount of, for example, from about 0.1 to about 35 percent by weight of the toner, or from about 1 to about 15 weight percent of the toner, or from about 3 to about 10 percent by weight of the toner, although amounts outside these ranges may be utilized.

### Preparation of Toner

The dry surface-treated pigment is added to a pre-toner mixture, such as before particle aggregation in the emulsion aggregation coalescence process. Adding or incorporating the pigment to the pre-toner mixture means that the pigment is added to, or incorporated into, the pre-toner mixture without first forming an external or secondary pigment dispersion. A binder resin, an optional wax, such as a wax dispersion, and any other desired or required additives, and emulsions including the resins described below, optionally surfactants as described below, may form the pre-toner mixture. The pre-toner mixture may be prepared and the pH of the resulting mixture may be adjusted by an acid such as, for example, acetic acid, nitric acid or the like. In embodiments, the pH of the mixture may be adjusted to from about 4 to about 5, although a pH outside this range may be utilized. Additionally, in embodiments, the mixture may be homogenized. If the mixture is homogenized, homogenization may be accomplished by mixing at about 600 to about 4,000 revolutions per minute, although speeds outside this range may be utilized. Homogenization may be accomplished by any suitable means, including, for example, an IKA ULTRA TURRAX T50 probe homogenizer.

Following the preparation of the above mixture, including the addition or incorporation of a dry surface-treated pigment directly into the pre-toner mixture, an aggregating agent may be added to the mixture. That is to say, the dry surface-treated pigment may be added prior to aggregation.

Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

In embodiments, the aggregating agent may be added to the mixture utilized to form a toner in an amount of, for example, from about 0.01 percent to about 8 percent by weight, in embodiments from about 0.1 percent to about 1 percent by weight, in other embodiments from about 0.15 percent to about 0.8 percent by weight, of the resin in the mixture, although amounts outside these ranges may be utilized. This may provide a sufficient amount of agent for aggregation.

To control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes, although more or less time may be used as desired or required. The addition of the agent may occur while the mixture is maintained under stirred conditions, in embodiments from about 50 revolutions per minute to about 1,000 revolutions per minute, in other embodiments from about 100 revolutions per minute to about 500 revolutions per minute, although speeds outside these ranges may be utilized. The addition of the agent may also occur while the mixture is maintained at a temperature that is below the glass transition temperature of the resin discussed above, in embodiments from about 30° C. to about 90° C., in embodiments from about 35° C. to about 70° C., although temperatures outside these ranges may be utilized.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours (although times outside these ranges may be utilized), while maintaining stirring, to provide the aggregated particles. Once the predetermined desired particle size is reached, then the growth process is halted. In embodiments, the predetermined desired particle size is within the desired size of the final toner particles.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C. (although temperatures outside these ranges may be utilized), which may be below the glass transition temperature of the resin as discussed above.

Once the desired final size of the toner particles is achieved, the pH of the mixture may be adjusted with a base to a value of from about 3 to about 10, and in embodiments from about 5 to about 9, although a pH outside these ranges may be utilized. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Core-Shell Structure

In embodiments, after aggregation, but prior to coalescence, a resin coating may be applied to the aggregated particles to form a shell thereover. Any resin described above as suitable for forming the toner resin may be utilized as the shell.

In embodiments, resins which may be utilized to form a shell include, but are not limited to, crystalline polyesters described above, and/or the amorphous resins described above for use as the core. For example, in embodiments, a polyalkoxylated bisphenol A-co-terephthalic acid/dodecenylsuccinic acid/trimellitic acid resin, a polyalkoxylated bisphenol A-co-terephthalic acid/fumaric acid/dodecenylsuccinic acid resin, or a combination thereof, may be combined with a polydodecanedioic acid-co-1,9-nonanediol crystalline polyester resin to form a shell. Multiple resins may be utilized in any suitable amounts.

The shell resin may be applied to the aggregated particles by any method within the purview of those skilled in the art. In embodiments, the resins utilized to form the shell may be in an emulsion including any surfactant described above. The emulsion possessing the resins may be combined with the aggregated particles described above so that the shell forms over the aggregated particles. In embodiments, the shell may have a thickness of up to about 5 microns, in embodiments of from about 0.1 to about 2 microns, in other embodiments, from about 0.3 to about 0.8 microns, over the formed aggregates, although thicknesses outside of these ranges may be obtained.

The formation of the shell over the aggregated particles may occur while heating to a temperature of from about 30° C. to about 80° C. in embodiments from about 35° C. to about 70° C., although temperatures outside of these ranges may be utilized. The formation of the shell may take place for a period of time of from about 5 minutes to about 10 hours, in embodiments from about 10 minutes to about 5 hours, although times outside these ranges may be used.

For example, in some embodiments, the toner process may include forming a toner particle by mixing the polymer latexes, in the presence of a wax dispersion and the surface-treated pigment of this disclosure, including, for example, the surface-treated titanium dioxide described above, with an optional coagulant while blending at high speeds. The resulting mixture having a pH of, for example, of from about 2 to about 3, is aggregated by heating to a temperature below the polymer resin Tg to provide toner size aggregates. Optionally, additional latex can be added to the formed aggregates providing a shell over the formed aggregates. The pH of the mixture may then be changed, for example by the addition of a sodium hydroxide solution, until a pH of about 7 may be achieved.

### Coalescence

Following aggregation to the desired particle size and application of any optional shell, the particles may then be coalesced to the desired final shape, the coalescence being achieved by, for example, heating the mixture to a temperature of from about 45° C. to about 100° C., in embodiments from about 55° C. to about 99° C. (although temperatures outside of these ranges may be used), which may be at or above the glass transition temperature of the resins utilized to form the toner particles, and/or reducing the stirring, for example to from about 100 revolutions per minute to about 1,000 revolutions per minute, in embodiments from about 200 revolutions per minute to about 800 revolutions per minute (although speeds outside of these ranges may be used). The fused particles can be measured for shape factor or circularity, such as with a Sysmex FPIA 2100 analyzer, until the desired shape is achieved.

Higher or lower temperatures may be used, it being understood that the temperature is a function of the resins used for the binder. Coalescence may be accomplished over a period of from about 0.01 hours to about 9 hours, in embodiments from about 0.1 hours to about 4 hours (although times outside of these ranges may be used).

After aggregation and/or coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Toner Resins

The resin used in the EA processes discussed above may be any latex resin utilized in forming EA toners. Such resins, in turn, may be made of any suitable monomer. Any monomer employed may be selected depending upon the particular polymer to be utilized. Two main types of emulsion aggregation toners are known. First is an emulsion aggregation process that forms acrylate based, e.g., styrene acrylate, toner particles. See, for example, U.S. Pat. No. 6,120,967, incorporated herein by reference in its entirety, as one example of such a process. Second is an emulsion aggregation process that forms polyester, e.g., sodio sulfonated polyester. See, for example, U.S. Pat. No. 5,916,725, incorporated herein by reference in its entirety, as one example of such a process.

Illustrative examples of latex resins or polymers selected for the non cross linked resin and cross linked resin or gel include, but are not limited to, styrene acrylates, styrene methacrylates, butadienes, isoprene, acrylonitrile, acrylic acid, methacrylic acid, beta-carboxy ethyl arylate, polyesters, known polymers such as polystyrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), polystyrene-butyl acrylate-methacrylic acid), poly(styrene-butyl acrylate-acrylonitrile), poly(styrene-butyl acrylate-acrylonitrile-acrylic acid), and the like, and mixtures thereof. In embodiments, the resin or polymer is a styrene/butyl acrylate/carboxylic acid terpolymer. In embodiments, at least one of the resin substantially free of cross linking and the cross linked resin comprises carboxylic acid in an amount of about 0.05 to about 10 weight percent based upon the total weight of the resin substantially free of cross linking or cross linked resin.

The monomers used in making the selected polymer are not limited, and the monomers utilized may include any one or more of, for example, styrene, acrylates such as methacrylates, butylacrylates, .beta.-carboxy ethyl acrylate (.beta.-CEA), etc., butadiene, isoprene, acrylic acid, methacrylic acid, itaconic acid, acrylonitrile, benzenes such as divinylbenzene, etc., and the like. Known chain transfer agents, for example dodecanethiol or carbon tetrabromide, can be utilized to control the molecular weight properties of the polymer. Any suitable method for forming the latex polymer from the monomers may be used without restriction. In embodiments, the resin that is substantially free of cross linking (also referred to herein as a non cross linked resin) comprises a resin having less than about 0.1 percent cross linking. For example, the non cross linked latex comprises in embodiments styrene, butylacrylate, and beta-carboxy ethyl acrylate (beta-CEA) monomers, although not limited to these monomers, termed herein as monomers A, B, and C, prepared, for example, by emulsion polymerization in the presence of an initiator, a chain transfer agent (CTA), and surfactant.

In embodiments, the resin substantially free of cross linking comprises styrene:butylacrylate:beta-carboxy ethyl acrylate wherein, for example, the non cross linked resin monomers are present in an amount of about 70 percent to about 90 percent styrene, about 10 percent to about 30 percent butylacrylate, and about 0.05 parts per hundred to about 10 parts per hundred beta-CEA, or about 3 parts per hundred beta-CEA, by weight based upon the total weight of the monomers, although not limited. For example, the carboxylic acid can be selected, for example, from the group comprised of, but not limited to, acrylic acid, methacrylic acid, itaconic acid, beta carboxy ethyl acrylate (beta CEA), fumaric acid, maleic acid, and cinnamic acid.

In a feature herein, the non cross linked resin comprises about 73 percent to about 85 percent styrene, about 27 percent to about 15 percent butylacrylate, and about 1.0 part per hundred to about 5 parts per hundred beta-CEA, by weight based upon the total weight of the monomers although the compositions and processes are not limited to these particular types of monomers or ranges. In another feature, the non cross linked resin comprises about 81.7 percent styrene, about 18.3 percent butylacrylate and about 3.0 parts per hundred beta-CEA by weight based upon the total weight of the monomers.

The initiator may be, for example, but is not limited to, sodium, potassium or ammonium persulfate and may be present in the range of, for example, about 0.5 to about 3.0 percent based upon the weight of the monomers, although not limited. The CTA may be present in an amount of from about 0.5 to about 5.0 percent by weight based upon the combined weight of the monomers A and B, although not limited. In embodiments, the surfactant is an anionic surfactant present in the range of about 0.7 to about 5.0 percent by weight based upon the weight of the aqueous phase, although not limited to this type or range.

In embodiments, the resin may be a polyester resin such as an amorphous polyester resin, a crystalline polyester resin, and/or a combination thereof. In further embodiments, the polymer utilized to form the resin may be a polyester resin described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, in embodiments from about 42 to about 55 mole percent, in embodiments from about 45 to about 53 mole percent (although amounts outside of these ranges can be used), and the alkali sulfo-aliphatic diol can be selected in an amount of from about 0 to about 10 mole percent, in embodiments from about 1 to about 4 mole percent of the resin (although amounts outside of these ranges can be used).

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent (although amounts outside of these ranges can be used), and the alkali sulfo-aliphatic diacid can be selected in an amount of from about 1 to about 10 mole percent of the resin (although amounts outside of these ranges can be used).

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof; and the like. Specific crystalline resins may be polyester based, such as poly(ethylene-adipate), polypropylene-adipate), poly(butylene-adipate), poly(pentylene-adipate), poly(hexylene-adipate), poly(octylene-adipate), poly(ethylene-succinate), polypropylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide), Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 10 to about 35 percent by weight of the toner components (although amounts outside of these ranges can be used). The crystalline resin can possess various melting points of, for example, from about 30° C. to about 120° C., in embodiments from about 50° C. to about 90° C. (although melting points outside of these ranges can be obtained). The crystalline resin may have a number average molecular weight (Mₙ), as measured by gel permeation chromatography (GPC) of, for example, from about 1,000 to about 50,000, in embodiments from about 2,000 to about 25,000 (although number average molecular weights outside of these ranges can be obtained), and a weight average molecular weight (M_{w}) of, for example, from about 2,000 to about 100,000, in embodiments from about 3,000 to about 80,000 (although weight average molecular weights outside of these ranges can be obtained), as determined by Gel Permeation Chromatography using polystyrene standards. The molecular weight distribution (M_{w}/Mₙ) of the crystalline resin may be, for example, from about 2 to about 6, in embodiments from about 3 to about 4 (although molecular weight distributions outside of these ranges can be obtained).

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin (although amounts outside of these ranges can be used).

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin (although amounts outside of these ranges can be used).

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin (although amounts outside of this range can be used).

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulf-o-isophthalate), copoly propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof. In embodiments, a suitable polyester resin may be a polyalkoxylated bisphenol A-co-terephthalic acid/dodecenylsuccinic acid/trimellitic acid resin, or a polyalkoxylated bisphenol A-co-terephthalic acid/fumaric acid/dodecenylsuccinic acid resin, or a combination thereof.

Such amorphous resins may have a weight average molecular weight (Mw) of from about 10,000 to about 100,000, in embodiments from about 15,000 to about 80,000.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

Suitable crystalline resins which may be utilized, optionally in combination with an amorphous resin as described above, include those disclosed in U.S. Patent Application Publication No. 2006/0222991, the disclosure of which is hereby incorporated by reference in its entirety. In embodiments, a suitable crystalline resin may include a resin formed of dodecanedioic acid and 1,9-nonanediol.

Such crystalline resins may have a weight average molecular weight (Mw) of from about 10,000 to about 100,000, in embodiments from about 14,000 to about 30,000.

For example, in embodiments, a polyalkoxylated bisphenol A-co-terephthalic acid/dodecenylsuccinic acid/trimellitic acid resin, or a polyalkoxylated bisphenol A-co-terephthalic acid/fumaric acid/dodecenylsuccinic acid resin, or a combination thereof, may be combined with a polydodecanedioic acid-co-1,9-nonanediol crystalline polyester resin.

In embodiments, the resins utilized may have a glass transition temperature of from about 30° C. to about 80° C., in embodiments from about 35° C. to about 70° C. In further embodiments, the resins may have a melt viscosity of from about 10 to about 1,000,000 Pa*S at about 130° C., in embodiments from about 20 to about 100,000 Pa*S. One, two, or more toner resins may be used. In embodiments where two or more toner resins are used, the toner resins may be in any suitable ratio (e.g., weight ratio) such as for instance about 10 percent (first resin)/90 percent (second resin) to about 90 percent (first resin)/10 percent (second resin). In embodiments, the resin may be formed by emulsion polymerization methods.

### Surfactants

In embodiments, colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered. However, the pigment is still added or incorporated directly into the toner formulation without first forming a pigment dispersion or a pigment emulsion.

One, two, or more surfactants may be utilized. The surfactants may be selected from ionic surfactants and nonionic surfactants. In embodiments, the latex for forming the resin utilized in forming a toner may be prepared in an aqueous phase containing a surfactant or co-surfactant, optionally under an inert gas such as nitrogen. Surfactants which may be utilized with the resin to form a latex dispersion can be ionic or nonionic surfactants in an amount of from about 0.01 to about 15 weight percent of the solids, and in embodiments of from about 0.1 to about 10 weight percent of the solids.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN R™, NEOGEN SC™ obtained from Daiichi Kogyo Seiyaku Co., Ltd., combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C12, C15, C17 trimethyl ammonium bromides, combinations thereof, and the like. Other cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride), available from Kao Chemicals, combinations thereof, and the like. In embodiments a suitable cationic surfactant includes SANISOL B-50 available from Kao Corp., which is primarily a benzyl dimethyl alkonium chloride.

Examples of nonionic surfactants include, but are not limited to, alcohols, acids and ethers, for example, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, combinations thereof, and the like. In embodiments commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be utilized.

The choice of particular surfactants or combinations thereof, as well as the amounts of each to be used, are within the purview of those skilled in the art.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles, although amounts outside these ranges may be utilized.

Waxes that may be selected include waxes having, for example, a weight average molecular weight of from about 500 to about 20,000, in embodiments from about 1,000 to about 10,000, although molecular weights outside these ranges may be utilized. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Other Additives

In embodiments, the toner particles may also contain other optional additives, as desired or required. For example, the toner may include positive or negative charge control agents, for example in an amount of from about 0.1 to about 10 percent by weight of the toner, in embodiments from about 1 to about 3 percent by weight of the toner (although amounts outside of these ranges may be used). Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Orient Chemical Industries, Ltd.); combinations thereof, and the like. Such charge control agents may be applied simultaneously with the shell resin described above or after application of the shell resin.

There can also be blended with the toner particles external additive particles after formation including flow aid additives, which additives may be present on the surface of the toner particles. Examples of these additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN 700, and mixtures thereof.

In general, silica may be applied to the toner surface for toner flow, tribo enhancement, admix control, improved development and transfer stability, and higher toner blocking temperature. TiO₂ may be applied for improved relative humidity (RH) stability, tribo control and improved development and transfer stability. Zinc stearate, calcium stearate and/or magnesium stearate may optionally also be used as an external additive for providing lubricating properties, developer conductivity, tribo enhancement, enabling higher toner charge and charge stability by increasing the number of contacts between toner and carrier particles. In embodiments, a commercially available zinc stearate known as Zinc Stearate L, obtained from Ferro Corporation, may be used. The external surface additives may be used with or without a coating.

Each of these external additives may be present in an amount of from about 0. 1 percent by weight to about 5 percent by weight of the toner, in embodiments of from about 0.25 percent by weight to about 3 percent by weight of the toner, although the amount of additives can be outside of these ranges. In embodiments, the toners may include, for example, from about 0.1 weight percent to about 5 weight percent titanium dioxide, from about 0.1 weight percent to about 8 weight percent silica, and from about 0.1 weight percent to about 4 weight percent zinc stearate (although amounts outside of these ranges may be used). Suitable additives include those disclosed in U.S. Pat. Nos. 3,590,000, 3,800,588, and 6,214,507, the disclosures of each of which are hereby incorporated by reference in their entirety. Again, these additives may be applied simultaneously with the shell resin described above or after application of the shell resin.

In embodiments, toners of the present disclosure may be utilized as ultra low melt (ULM) toners. In embodiments, the dry toner particles having a core and/or shell may, exclusive of external surface additives, have one or more the following characteristics: (1) Volume average diameter (also referred to as “volume average particle diameter”) was measured for the toner particle volume and diameter differentials. The toner particles have a volume average diameter of from about 3 to about 25 μm, in embodiments from about 4 to about 15 μm, in other embodiments from about 5 to about 12 μm (although values outside of these ranges may be obtained).

(2) Number Average Geometric Size Distribution (GSDn) and/or Volume Average Geometric Size Distribution (GSDv): In embodiments, the toner particles described in (1) above may have a very narrow particle size distribution with a lower number ratio GSD of from about 1.15 to about 1.38, in other embodiments, less than about 1.31 (although values outside of these ranges may be obtained). The toner particles of the present disclosure may also have a size such that the upper GSD by volume in the range of from about 1.20 to about 3.20, in other embodiments, from about 1.26 to about 3.11 (although values outside of these ranges may be obtained). Volume average particle diameter D.sub.50v, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10 percent, with the sample then run in a Beckman Coulter Multisizer 3.

(3) Shape factor of from about 105 to about 170, in embodiments, from about 110 to about 160, SF1*a (although values outside of these ranges may be obtained). Scanning electron microscopy (SEM) may be used to determine the shape factor analysis of the toners by SEM and image analysis (IA). The average particle shapes are quantified by employing the following shape factor (SF1*a) formula: SF1*a=100πd²/(4A), where A is the area of the particle and d is its major axis. A perfectly circular or spherical particle has a shape factor of exactly 100. The shape factor SF1*a increases as the shape becomes more irregular or elongated in shape with a higher surface area.

(4) Circularity of from about 0.92 to about 0.99, in other embodiments, from about 0.94 to about 0.975 (although values outside of these ranges may be obtained). The instrument used to measure particle circularity may be an FPIA-2100 manufactured by Sysmex.

The characteristics of the toner particles may be determined by any suitable technique and apparatus and are not limited to the instruments and techniques indicated hereinabove.

In embodiments, the toner particles may have a weight average molecular weight (Mw) in the range of from about 17,000 to about 80,000 daltons, a number average molecular weight (Mₙ) of from about 3,000 to about 10,000 daltons, and a MWD (a ratio of the M_{w} to Mₙ of the toner particles, a measure of the polydispersity, or width, of the polymer) of from about 2.1 to about 10 (although values outside of these ranges may be obtained).

Toners produced in accordance with the present disclosure may possess excellent charging characteristics when exposed to extreme relative humidity (RH) conditions. The low-humidity zone (C zone) may be about 12° C./15 percent RH, while the high humidity zone (A zone) may be about 28° C./85 percent RH (although values outside of these ranges may be obtained). Toners of the present disclosure may possess a parent toner charge per mass ratio (Q/M) of from about −2 μC/g to about −28 μC/g, in embodiments from about −4 μC/g to about −25 μC/g (although values outside of these ranges may be obtained), and a final toner charging after surface additive blending of from −8 μC/g to about −25 μC/g, in embodiments from about −10 μC/g to about −22 μC/g (although values outside of these ranges may be obtained).

### Developer

The toner particles formed from the processes disclosed herein, including adding a dry surface-treated pigment directly into the pre-toner mixture without first forming a separate pigment dispersion or emulsion, may then be formulated into a developer composition. For example, the toner particles may be mixed with carrier particles to achieve a two-component developer composition. The carrier particles can be mixed with the toner particles in various suitable combinations. The toner concentration in the developer may be from about 1 percent to about 25 percent by weight of the developer, in embodiments from about 2 percent to about 15 percent by weight of the total weight of the developer (although values outside of these ranges may be used). In embodiments, the toner concentration may be from about 90 percent to about 98 percent by weight of the carrier (although values outside of these ranges may be used). However, different toner and carrier percentages may be used to achieve a developer composition with desired characteristics.

### Carriers

Illustrative examples of carrier particles that can be selected for mixing with the toner composition prepared in accordance with the present disclosure include those particles that are capable of triboelectrically obtaining a charge of opposite polarity to that of the toner particles. Accordingly, in one embodiment the carrier particles may be selected so as to be of a negative polarity in order that the toner particles that are positively charged will adhere to and surround the carrier particles. Illustrative examples of such carrier particles include granular zircon, granular silicon, glass, silicon dioxide, iron, iron alloys, steel, nickel, iron ferrites, including ferrites that incorporate strontium, magnesium, manganese, copper, zinc, and the like, magnetites, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include polyolefins, fluoropolymers, such as polyvinylidene fluoride resins, terpolymers of styrene, acrylic and methacrylic polymers such as methyl methacrylate, acrylic and methacrylic copolymers with fluoropolymers or with monoalkyl or dialkylamines, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 weight percent to about 70 weight percent, in embodiments from about 40 weight percent to about 60 weight percent (although values outside of these ranges may be used). The coating may have a coating weight of, for example, from about 0.1 weight percent to about 5 percent by weight of the carrier, in embodiments from about 0.5 weight percent to about 2 percent by weight of the carrier (although values outside of these ranges may be obtained).

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 weight percent to about 10 weight percent, in embodiments from about 0.01 weight percent to about 3 weight percent, based on the weight of the coated carrier particles (although values outside of these ranges may be used), until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size (although sizes outside of these ranges may be used), coated with about 0.5 percent to about 10 percent by weight, in embodiments from about 0.7 percent to about 5 percent by weight (although amounts outside of these ranges may be obtained), of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1 percent to about 20 percent by weight of the toner composition (although concentrations outside of this range may be obtained). However, different toner and carrier percentages may be used to achieve a developer composition with desired characteristics.

### Imaging

Toners formed from the EA toner processes of the present disclosure may be utilized in electrostatographic (including electrophotographic) or xerographic imaging methods, including those disclosed in, for example, U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art. Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C. (although temperatures outside of these ranges may be used), after or during melting onto the image receiving substrate.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

Examples 1 and 2 describe the preparation of toner particles where a dry surface-treated pigment was added directly to the EA process before the start of aggregation according to the present disclosure. TGA measurements of the particles show that substantially all of the dry surface-treated pigment added to the process was incorporated into the final product.

### Example 1

### Toner Prepared with 15 Percent by Weight of Dry Surface-Treated TiO₂

The following components were added to a 2 liter plastic beaker: about 535 grams of deionized water; about 4.0 grams of DOWFAX™ 2A1 anionic surfactant, which is an alkyldiphenyloxide disulfonate commercially available from The Dow Chemical Company; about 109 grams of an amorphous polyester resin emulsion (Amorphous Resin Emulsion A) containing about 33.8 percent by weight of a linear amorphous polyester resin derived from terephthalic acid, dodecenylsuccinic acid, trimellitic acid, ethoxylated bisphenol A and propoxylated bisphenol A with weight-average molecular weight of about 86,000 and onset glass temperature of about 56° C.; about 105 grams of another amorphous polyester resin emulsion (Amorphous Resin Emulsion B) containing about 35.15 percent by weight of a linear amorphous polyester resin derived from terephthalic acid, fumaric acid, dodecenylsuccinic acid, ethoxylated bisphenol A and propoxylated bisphenol A with a weight-average molecular weight of about 19,400 and onset glass transition temperature of about 60.5° C.; about 35 grams of a crystalline polyester resin emulsion (Crystalline Resin Emulsion C) containing about 34.8 percent by weight crystalline polyester resin derived from 1,12-dodecanedioic acid and 1,9-nonanediol with weight-average molecular weight of about 23,300, number-average molecular weight of about 10,500 and melting temperature of about 71° C.; and about 54 grams of a wax emulsion containing about 30 percent by weight polymethylene wax available from International Waxes, Inc.

The mixture was stirred for about 2 minutes using an IKA Ultra Turrax® T50 probe homogenizer operating at about a speed of from about 3,500 to about 4,000 revolutions per minute. Thereafter about 26.3 grams of R-706 titanium dioxide powder available from DuPont was added during the homogenization for 1 minute and followed by addition of about 23 grams of 0.3M HNO3 solution to lower the pH to about 4.5. Thereafter, about 3.1 grams of Al₂(SO₄)₃ mixed with about 39 grams of deionized water as a flocculent was added drop-wise to the beaker and homogenized for 5 minutes. The mixture was transferred to a 2 L Buchi reactor, degassed for about 20 minutes at about 300 revolutions per minute and then heated at 1° C. per minute to a reactor jacket temperature of about 51.5° C. at about 450 revolutions per minute for aggregation. The particle size was monitored using the Coulter Counter until the particle size reached about 4.6 to about 4.8 micrometers. The shell mixture comprising about 74 grams of Amorphous Resin Emulsion A, about 71 grams of Amorphous Resin Emulsion B and about 18 grams of deionized water, was immediately introduced into the reaction and allowed to aggregate for another 100 minutes at the reactor jacket of about 51.5° C. at a stirring speed of about 390 revolutions per minute.

Thereafter, the pH of the toner slurry was increased to about 4.5 using about 1M NaOH, followed by the addition of about 6.7 grams of Versene 100 chelating solution containing about 39 percent by weight EDTA mixed with about 40 grams of deionized water. Thereafter the stirring rate was lowered to 160 revolutions per minute and the pH was raised to 7.9 by the addition of about 1M NaOH to freeze the toner growth. After freezing, the reactor mixture was heated to about 80° C. to enable the toner particles to coalesce and spherodize. The reactor heater was then turned off and the reactor mixture was rapidly cooled to room temperature with the addition of ice, and then filtered through a 25 micrometer sieve, washed and dried.

The final toner had a volume average particle size diameter of about 5.77 micrometers, a GSDv of about 1.22 and GSDn of about 1.23 as measured by a Coulter Counter, and a circularity of about 0.974 as measured with a SYSMEX® FPIA-2100 flow-type histogram analyzer. The particle data are summarized in Table 1.

### Example 2

### Toner Prepared with 31 Percent by Weight of Dry Surface-Treated TiO₂

According to the procedure of Example 1, the following components were added to a 2 liter plastic beaker: about 598 grams of deionized water; about 8.3 grams of DOWFAX™ 2A1 anionic surfactant; about 66 grams of Amorphous Resin Emulsion A; about 64 grams of Amorphous Resin Emulsion B, 35 grams of Crystalline Resin Emulsion C; and about 54 grams of a wax emulsion containing about 30 percent by weight polymethylene wax. The mixture was stirred for about 2 minutes using an IKA Ultra Turrax® T50 probe homogenizer operating at about a speed of from about 3,500 to about 4,000 revolutions per minute. Thereafter about 54.3 grams of R-706 titanium dioxide powder was added during the homogenization for 1 minute and followed by addition of about 18 grams of 0.3M HNO3 solution to lower the pH to about 4.5.

Thereafter, about 3.1 grams of Al₂(SO₄)₃ mixed with about 39 grams of deionized water as a flocculent was added drop-wise to the beaker and homogenized for 5 minutes. The mixture was transferred to a 2 L Buchi reactor, degassed for about 20 minutes at about 300 revolutions per minute and then heated at 1° C. per minute to a reactor jacket temperature of about 51.5° C. at about 410 revolutions per minute for aggregation. The particle size was monitored using the Coulter Counter until the particle size reached about 4.6 to about 4.8 micrometers. The shell mixture comprising about 74 grams of Amorphous Resin Emulsion A, about 71 grams of Amorphous Resin Emulsion B and about 18 grams of deionized water, was immediately introduced into the reaction and allowed to aggregate for another 165 minutes at the reactor jacket of about 51.5° C. at a stirring speed of about 440 revolutions per minute.

Thereafter, the pH of the toner slurry was increased to about 4.5 using about 1 M NaOH, followed by the addition of about 6.7 grams of Versene 100 chelating solution with about 40 grams of deionized water. Thereafter the stirring rate was lowered to 160 revolutions per minute and the pH was raised to 7.9 by the addition of about 1 M NaOH to freeze the toner growth. After freezing, the reactor mixture was heated to about 80° C. to enable the toner particles to coalesce and spherodize. The reactor heater was then turned off and the reactor mixture was rapidly cooled to room temperature with the addition of ice, and then filtered through a 25 micrometer sieve, washed and dried.

The final toner had a volume average particle size diameter of about 6.21 micrometers, a GSDv of about 1.27 and GSDn of about 1.27 as measured by a Coulter Counter, and a circularity of about 0.964 as measured with a SYSMEX® FPIA-2100 flow-type histogram analyzer.

TABLE 1
Summary of toner particle information.

| | TiO₂ | TGA | | | | | Moisture |
|---|---|---|---|---|---|---|---|
| | Input | Residue | D₅₀ | | | Circu- | Content |
| | (wt %) | (wt %) | (μm) | GSDv | GSDn | larity | (%) |
| Ex 1 | 15.0 | 14.99 | 5.77 | 1.219 | 1.232 | 0.974 | 0.51 |
| Ex 2 | 31.0 | 31.01 | 6.21 | 1.272 | 1.272 | 0.964 | 0.53 |

TGA Measurement

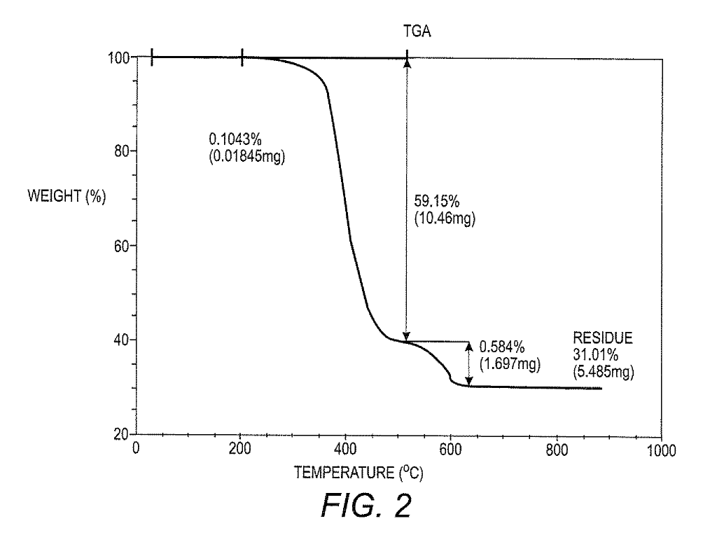

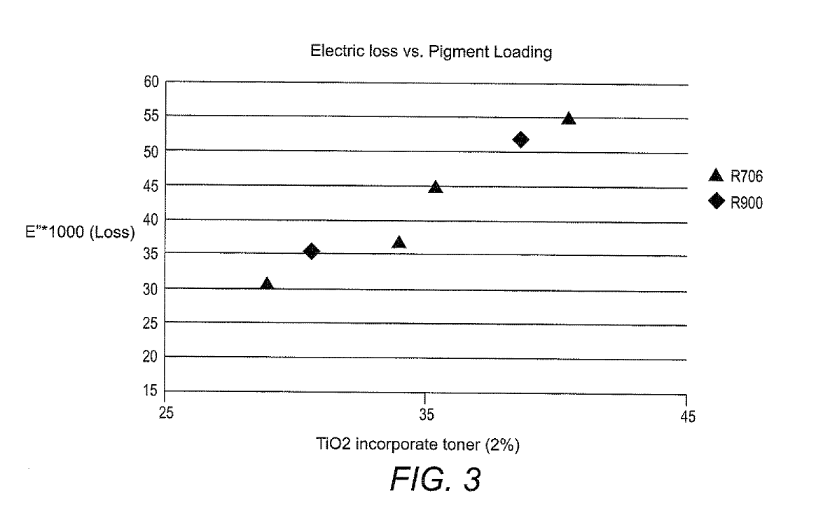

As shown in FIGS. 2 and 3, thermogravimetric (TGA) measurements verify the successful incorporation of the TiO₂ into toner. The variation of the data is within experimental uncertainty.

### Additional Examples

Following the preparation of the toner particles of Examples 1 and 2, additional work was carried out in which a number of white toner particles were prepared in manner similar to that described in Examples 1 and 2 using dry TiO2 powder, or in which a TiO₂ predispersion containing DOWFAX™ 2Al anionic surfactant and deionized water was used instead of dry TiO₂ powder and wherein two grades of treated TiO₂ powders were utilized, R-706 and R-900 available from DuPont. No difference was seen in the final toner particles where dry TiO₂ powder or aqueous TiO₂ dispersions were utilized.

Color Space

TABLE 3
Color space measurements.

| | | Pigment | | L* at different | | | |
|---|---|---|---|---|---|---|---|
| | | Loading (%) | | TMA (mg/cm²) | | | |
| | Pigment | Nominal | Actual | 0.5 | 1 | 2 | 3 |
| Example 3 | R-706 | 35 | 21.93 | 55.41 | 70.21 | 81.86 | 88.39 |
| Example 4 | | 35 | 33.96 | 62.90 | 78.35 | 87.15 | 91.58 |
| Example 5 | | 40 | 35.34 | 63.65 | 76.42 | 87.34 | 91.60 |
| Example 6 | | 45 | 40.42 | 64.91 | 78.27 | 87.51 | 92.81 |
| Example 7 | R-900 | 31 | 30.6% | 61.30 | 72.89 | 84.45 | 89.74 |
| Example 8 | | 40 | 38.58 | 63.75 | 79.65 | 88.66 | 92.59 |

Most particles meet or exceed requirement of L*>75 with the exception of developed amount of toner (TMA) at 0.5 mg/cm².

Charging

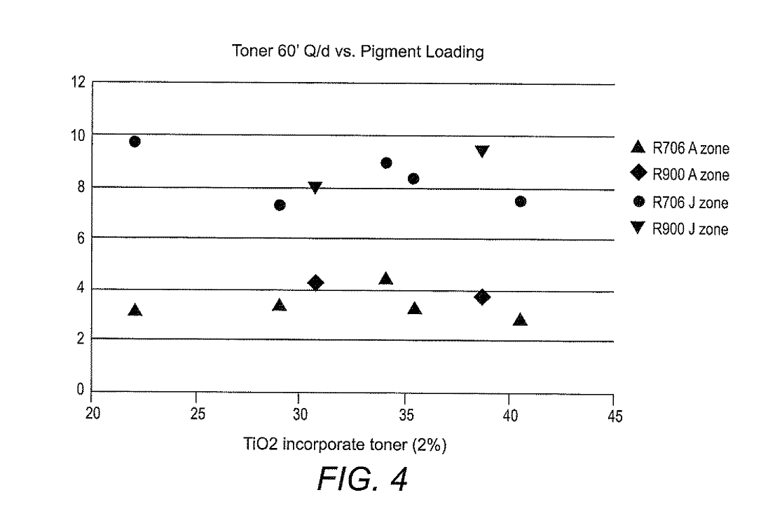

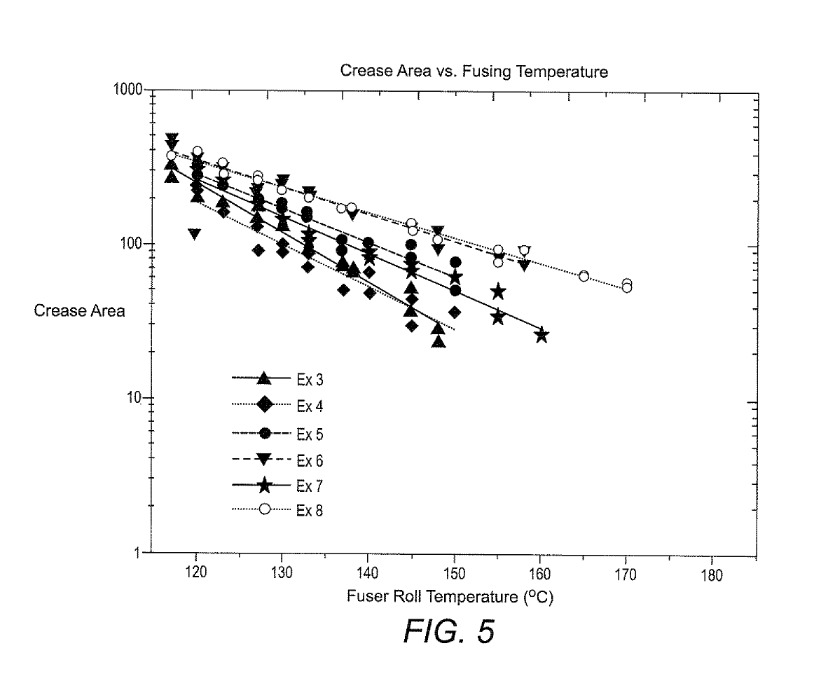

FIGS. 4 and 5 show that dielectric loss of white toner is higher than nominal toners and increases with increasing pigment loading (TiO₂ is conductive). Dielectric loss may be less than 50. Toners containing TiO₂ have lower charge than nominal toners.

### Fusing

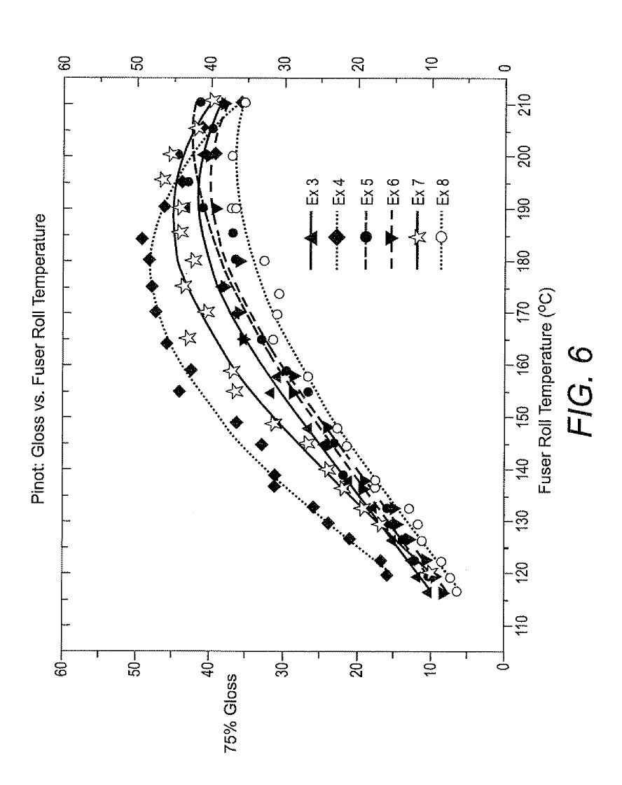

FIGS. 6 and 7 show that crease fix increases and gloss decreases with increased pigment loading.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of making toner particles, comprising:
forming a pre-toner mixture by mixing dry surface-treated pigment particles, at least one amorphous resin emulsion, an optional crystalline resin emulsion, and an optional wax emulsion;
aggregating particles from the pre-toner mixture;
halting the aggregating of the particles; and
coalescing the particles to form toner particles,
wherein the dry surface-treated pigment particles are added directly to the pre-toner mixture without first fainting a pigment dispersion.

2. The method according to claim 1, wherein the dry surface-treated pigment particles are added prior to the step of aggregating particles from the pre-toner mixture.

3. The method according to claim 1, wherein the dry surface-treated pigment particles are subjected to an organic surface treatment.

4. The method according to claim 1, wherein the dry surface-treated pigment particles comprise a pigment selected from the group consisting of carbon black, white, cyan, magenta, and yellow pigments.

5. The method according to claim 4, wherein the dry surface-treated pigment particles comprise titanium dioxide having a refractive index of from about 2.4 to about 3.

6. The method according to claim 5, wherein the dry surface-treated pigment particles comprising titanium dioxide are subjected to a surface treatment selected from at least one treatment selected from the group consisting of a silicon dioxide treatment, an alumina treatment, and an organic treatment.

7. The method according to claim 1, wherein the pre-toner mixture further comprises a pre-dispersed pigment.

8. The method according to claim 1, wherein there is no external or secondary step of creating a pigment dispersion.

9. The method according to claim 1, wherein the aggregation step produces aggregated particles and, prior to the coalescence step, a resin coating is applied to the aggregated particles to form a shell thereover.

10. The method according to claim 3, wherein the organic treatment contains aliphatic hydrocarbons with at least one functionality selected from the group ether, ester, and hydroxyl functionalities, wherein the weight fraction of the organic surface coating ranges from about 0.1% to about 5%.

11. The method according to claim 1, wherein the dry surface-treated pigment is added in an amount of from about 1 weight percent to about 50 weight percent of the toner.

12. The method according to claim 1, wherein an aggregating agent is added to the pre-toner mixture after the dry surface-treated pigment particles are added to the pre-toner mixture.

13. The method according to claim 12, wherein the aggregating agent is selected from the group consisting of polyaluminum halides, polyaluminum silicates, aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof.

14. The method according to claim 12, wherein the aggregating agent is added to the pre-toner mixture in an amount of from about 0.01 percent to about 8 percent.

15. A method of forming a developer comprising:
forming a pre-toner mixture by mixing dry surface-treated pigment particles, at least one amorphous resin emulsion, an optional crystalline resin emulsion, and an optional wax emulsion;
aggregating particles from the pre-toner mixture;
halting the aggregating of the particles;
coalescing the particles to form toner particles; and
mixing the toner particles with carrier particles to form a developer,
wherein the dry surface-treated pigment particles are added directly to the pre-toner mixture without first forming a pigment dispersion.

16. The method according to claim 15, wherein the dry surface-treated pigment particles are added prior to the step of aggregating particles from the pre-toner mixture.

17. The method according to claim 15, wherein the dry surface-treated pigment particles are subjected to an organic surface treatment.

18. The method according to claim 15, wherein the dry surface-treated pigment particles comprise a pigment selected from the group consisting of carbon black, white, cyan, magenta, and yellow pigments.

19. The method according to claim 15, wherein the pigment particles comprise titanium dioxide having a refractive index of from about 2.4 to about 3.

20. A method of making toner particles, comprising:
forming a pre-toner mixture by mixing dry surface-treated pigment particles, at least one amorphous resin emulsion, an optional crystalline resin emulsion, a wax emulsion, and a surfactant;
aggregating particles from the pre-toner mixture to form aggregated particles;
applying a resin coating to the aggregated particles to form a shell thereover; and
coalescing the aggregated particles to form toner particles,
wherein the dry surface-treated pigment particles are added directly to the pre-toner mixture without first forming a pigment dispersion; and
the dry surface-treated pigment particles are subjected to a surface treatment selected from at least one treatment selected from the group consisting of a silicon dioxide treatment, an alumina treatment, and an organic treatment.
